(19) United States
(12) Patent Application Publication
(10) Pub. No.: US 2007/0236333 A1
(43) Pub. Date: Oct. 11, 2007

(54) Data carrier-/transmitter device and a method for the production of a data carrier-/transmitter device

(75) Inventor: Dieter Reuker, Stuttgart (DE)

Correspondence Address: Lipsitz & McAllister, LLC, 755 MAIN STREET, MONROE, CT, 06468, US

(73) Assignee: BALLUFF GmbH, Neuhausen (DE)

(21) Appl. No.: 11/732,695

(22) Filed: Apr. 3, 2007

(30) Foreign Application Priority Data
Apr. 7, 2006 (DE) 10 2006 017 992.7

(51) Int. Cl. H04Q 5/22

(52) U.S. Cl. 340/10.1

(57) ABSTRACT

There is proposed a data carrier-/transmitter device for fixing to an object, comprising an oscillatory circuit including at least one coil, an electrical circuit arrangement to which the at least one coil is coupled, and a fixing device including a contact face for the object, wherein the coil axis of the at least one coil is at least approximately parallel to the contact face of the fixing device.

The present disclosure relates to the subject matter disclosed in German application number 10 2006 017 992.7 of Apr. 7, 2006, which is incorporated herein by reference in its entirety and for all purposes.

### BACKGROUND OF THE INVENTION

The invention relates to a data carrier-/transmitter device for fixing to an object, comprising an oscillatory circuit including at least one coil, an electrical circuit arrangement to which the at least one coil is coupled and a fixing device having a contact face for the object.

Furthermore, the invention relates to a method for the production of a data carrier-/transmitter device incorporating an oscillatory circuit.

Data carrier devices are utilised for identifying objects for example. The data carrier device comprises an oscillatory circuit by means of which a transponder is formed with which data can be read and also stored in non-contact making manner and without visual contact. Stored data can be rapidly and automatically identified by a transmit-receive unit which comprises a transmitter device.

An rfid label, which is fixable directly onto metallic surfaces and makes it possible to read and write within a certain range, is known from the product information brochure “((rfid))-onMetal-Label” issued by Schreiner LogiData GmbH & Co. Kg, Waldvoegeleinstrasse 12, 80995 Munich, www.schreiner-online.com.

### SUMMARY OF THE INVENTION

In accordance with the invention a data carrier-/transmitter device is provided, which is suitable for a metallic object and has a large response range.

In accordance with an embodiment of the invention, in the data carrier-/transmitter device the coil axis of the at least one coil is at least approximately parallel to the contact face of the fixing device.

Due to this alignment of the at least one coil, the coil axis is at least approximately in parallel with the surface region of the object to which the data carrier device is fixed via the contact face. The lines of flux (and in particular the inductive field) of a transmit-receive device then run substantially parallel to the surface of the metallic object. The field in front of the object is thereby compressed. This thus results in a relatively large response range.

It can thereby be ensured for example, that when metallic objects which are provided with the data carrier device in accordance with the invention are fed past a read head, the read head will not have to be moved towards the object in order to enable data to be read out from the data carrier device.

For example, the contact face is a substantially flat contact surface. The data carrier device can thereby be fixed to an object by the fixing device in a simple manner.

Due to the teaching in accordance with the invention, a transmitter device can also be realized which is fixable to a metallic object thereby producing a transmission field which enables a large response range to be obtained. In particular, the transmitter device cooperates with a data carrier device which comprises a resonant circuit including at least one coil and an electrical circuit arrangement. The transmitter device forms an antenna device for applying an electromagnetic field to a data carrier device. The data carrier device, by means of which the transmitter device in accordance with the invention cooperates, can be formed in accord with the technical teachings of the invention or may have some other design.

It is expedient for the fixing device to comprise one or more through openings for attachment elements. It can thus be fixed to an object in a simple manner.

In particular, the object is a metallic object. By virtue of the data carrier device in accordance with the invention, metallic objects such as engine blocks for example can be provided with an identification code which is readable in a simple manner since a large response range has been made available.

It is also possible to provide a transmitter device, in particular, for fixing on a metallic object.

Furthermore, in accordance with the invention there is provided a metal element which is arranged between the at least one coil and the object.

The resonant frequency of the oscillatory circuit is shifted by a metallic object, usually, to higher frequencies. If the data carrier-/transmitter device contains a metal element, then this metal element provides for an “intrinsic” displacement of the point of resonance. The influence of the external metallic object is thereby reduced since the displacement of the point of resonance caused by the external metallic object is greatly reduced. This likewise contributes to the resultant relatively large response range (the distance between the object which is provided with the data carrier device, and the transmit-receive device).

It is expedient for production purposes, if the metal element is at least partially in the form of a plate or foil. It can then be positioned relative to the coil in a simple manner. A metal element in the form of a plate can be used as a carrier for a coil.

It is especially very advantageous if the metal element masks the at least one coil from the object. In consequence, the influence which an external object exerts on the resonant circuit and in particular the displacement of the point of resonance is greatly reduced.

It is particularly advantageous then if the metal element is of at least the same width transverse to the coil axis and is of at least the same length parallel to the coil axis as the at least one coil.

It is expedient for production purposes, if the metal element is formed as a backing plate of the data carrier-/transmitter device. In consequence, just one component serves as a carrier for the coil and as a metal element for the “intrinsic” displacement of the resonant frequency. Furthermore, the backing plate can be used as a fixing device.

In particular, the fixing device is at least partly formed by the metal element. The corresponding data carrier-/transmitter device can then be manufactured in a simple manner.

For example, the metal element is made of aluminium or steel (such as high-grade steel for example) or copper. Thus, to a large extent, an external displacement of the resonant frequency by a metallic object can be prevented in a simple manner.

It is expedient, if the metal element forms a carrier for the at least one coil and/or the electrical circuit arrangement. The corresponding data carrier-/transmitter device can thereby be manufactured in a simple manner.

It is then expedient if the metal element has a substantially flat upper surface. A coil comprising a coil core can then be positioned on and fixed to the metal element in a simple manner.

It is expedient, if the fixing device comprises one or more edge strips. Thus centring of the coil (which is arranged on a coil core in particular) on the fixing device can be achieved in order to simplify the production of the data carrier-/transmitter device.

In particular, the at least one edge strip is made of a metallic material in order to provide for a displacement of the resonant frequency so that, in turn, a displacement of the resonant frequency due to the external influence of an object is greatly decreased.

In particular, the at least one edge strip is connected to a plate-like metal element. A corresponding data carrier-/transmitter device can be manufactured in a simple manner.

It is expedient hereby, for the at least one edge strip to be oriented at least approximately parallel to the coil axis of the at least one coil. Consequently, with respect to the path of the lines of flux of the inductive field, the data carrier device is “open” in parallel with the coil axis so that effective coupling to an inductive field of a transmit-receive device is thereby possible.

It is expedient if a seating space for the at least one coil and/or the circuit arrangement is formed between opposite edge strips. For example, a combination of a coil core and a coil and optionally a circuit arrangement can be positioned in this seating space. In turn thereby, the data carrier-/transmitter device can be manufactured in a simple manner.

It is expedient if the end of the seating space is open with respect to the coil axis. In consequence, the path of the lines of flux in parallel with the contact face and hence in parallel with the surface of an object is not substantially obstructed.

The seating space is parallelepipedal for example. In consequence, a data carrier-/transmitter device of small height dimensions can be formed.

In particular, the electrical circuit arrangement comprises a capacitive device. The oscillatory circuit can thus be manufactured in a simple manner since the oscillatory circuit capacitance is integrated into the electrical circuit arrangement.

It is expedient if the electrical circuit arrangement is formed by one or more integrated circuits. These are integrated, in particular, in a small number of components, whereby it is particularly advantageous for the electrical circuit arrangement to comprise just one IC. The data carrier-/transmitter device can then be manufactured in a simple manner.

It is expedient if one or more trimming capacitors are associated with the electrical circuit arrangement. The properties of components or the materials of the components can vary. These variations can be compensated by one or more trimming capacitors by means of an appropriate trimming process during the production of the data carrier-/transmitter device in order to produce data carrier-/transmitter devices whose properties only vary to a small extent.

It is expedient for a coil core to be associated with the at least one coil. This coil core serves to “collect” and “focus” the lines of flux in order to obtain a large response range. The coil core is made of a soft-magnetic material. For example, the coil core is made of a ferrite material.

It is particularly expedient, if the coil core is at least approximately parallelepipedal. A data carrier-/transmitter device which is small in height can thereby be formed.

It is especially very advantageous, if the at least one coil comprises turns which are arranged around the coil core. A coil whose coil axis is in parallel with the contact face can thereby be produced in a simple manner.

It is expedient for the turns of the at least one coil to comprise winding portions which are oriented at least approximately parallel to the contact face. A coil can thus be produced which is of flat construction. In turn thereby, the data carrier-/transmitter device can be produced such that it is small in height.

It is then particularly advantageous if at least 80% and preferably at least 90% of the total winding length of the coil is parallel to the contact face. The coil can thereby be of flat construction with a coil axis in parallel with the contact face.

It is especially very advantageous, if the coil core is made of a flexural material. Ferrite rods have the fundamental problem that they are very brittle and can easily break. The production of the data carrier-/transmitter device is simplified by the use of the flexural material. Soft-magnetic materials which are suitable as coil cores and are flexural are, for example, amorphous metals.

For the same reason, it is expedient if the coil core is made of a foil material. It is then possible to a certain extent for the data carrier-/transmitter device to be of flexible construction so as to enable it to adapt to the surface contours of an object.

Provision may be made for the at least one coil to be wound at least partly round the circuit arrangement. This thus results in a simple construction so that the data carrier-/transmitter device is producible such that it is of small dimensions. Care must be taken hereby to ensure that the coil and the circuit arrangement are not short circuited.

Provision may be made for the data carrier-/transmitter device to comprise a flexi-rigid composite of printed circuit boards. A flexi-rigid composite of printed circuit boards comprises rigid printed circuit board elements which are connected together in a flexible manner. A corresponding data carrier-/transmitter device can then be produced in a simple and economical manner.

In particular, provision is made for a first printed circuit board element on which winding portions of the at least one coil are arranged.

Furthermore it is expedient, if provision is made for a second printed circuit board element on which winding portions of the at least one coil are arranged, whereby the second printed circuit board element is connected to the first printed circuit board element in flexible manner. A coil which surrounds the coil core can then be obtained by appropriate positioning of the first printed circuit board element and the second printed circuit board element relative to one another with a coil core therebetween.

In particular, the connection is effected via the winding portions of the at least one connection, i.e. the winding portions provide the flexible connection between the rigid printed circuit board elements.

Furthermore, provision may be made for a third printed circuit board element around which winding portions of the at least one coil are arranged, whereby the third printed circuit board element is connected to the first printed circuit board element in flexible manner.

In particular, the flexible connection is effected by winding portions of the at least one coil. The entire coil can then be produced from the partial coils of the second printed circuit board element and the third printed circuit board element, the entire coil then surrounding the coil core.

For example, the circuit arrangement is arranged on the second printed circuit board element. The data carrier-/transmitter device can thereby be produced in a simple manner, whereby the beginning of a respective coil or the end of a respective coil can be connected directly to the circuit arrangement.

It is expedient for the second printed circuit board element and/or the third printed circuit board element to be arranged opposite the first printed circuit board element. A coil core can then be positioned between them.

It is especially very advantageous, if a coil core is arranged between the first printed circuit board element and the second printed circuit board element and/or the third printed circuit board element. A combination of a coil core, a coil surrounding the coil core and a circuit arrangement can then be produced in a simple manner using a flexi-rigid composite of printed circuit boards.

The production process is simplified, if the second printed circuit board element and/or the third printed circuit board element rest on the coil core.

The coil core then serves to provide a contact surface for the printed circuit board element or the printed circuit board elements.

Furthermore, in accordance with the invention a method is provided for the production of a data carrier-/transmitter device including an oscillatory circuit which is implementable in a simple and economical manner.

In accordance with an embodiment of the invention, the beginning of a coil is fixed to a circuit arrangement and the circuit arrangement is fixed to a coil core.

The coil can then be produced by winding or over a flexi-rigid composite of printed circuit boards for example, without the need to rotate or turn a coil carrier.

Further advantageous methods have already been described in connection with the data carrier-/transmitter device in accordance with the invention.

In particular, the coil is produced on the coil core. For example, the coil is wound around the coil core. Thus, the coil core does not have to be rotated or turned, but a winding machine can be utilised.

For example, the coil core is produced in the form of a foil. In comparison with a ferrite rod, the danger of fracture is thereby greatly reduced. Furthermore, matching to different applications of objects can be realized.

For example, the coil core is in the form of a parallelepiped. Data carrier devices which are small in height can thereby be produced.

For the same reason, it is expedient if the coil is wound flat.

Furthermore, it is expedient if the end of a coil is fixed to the circuit arrangement. The fixing process is effected by welding or soldering for example. The coil can thus be coupled to the circuit arrangement in a simple manner.

Furthermore, it is expedient for the combination of a coil core and a coil and a circuit arrangement to be fixed to a fixing device for the purposes of fixing the data carrier-/transmitter device to an object. The data carrier-/transmitter device can then be produced in a simple manner such that it is small in height.

It is especially very advantageous, if a metal element is positioned on the combination consisting of a coil device and a coil and a circuit arrangement. An “intrinsic” displacement of the resonant frequency is thereby obtained, this then greatly reducing the influence of an external metallic object on the resonant frequency. In turn, one then achieves a large response range.

In particular, the fixing device is formed by a metal plate or comprises a metal plate. The data carrier-/transmitter device can thereby be produced in a simple manner.

It is especially very advantageous, if a trimming device is produced. Variations in the components or variations in the materials can thereby be compensated by a trimming action during the production process.

In particular, a trimming action is effected on a produced data carrier-/transmitter device so that there is only a small spread across the end products.

Provision may be made for a first printed circuit board element having a partial coil to be produced and at least one further printed circuit board element having a further partial coil to be produced, whereby the first printed circuit board element and the at least one further printed circuit board element are connected together in flexible manner by portions of the coil. The data carrier-/transmitter device can be produced in a simple manner using such a flexi-rigid composite of printed circuit boards. A coil which surrounds a coil core can be produced, whereby the turns can be printed thereon in the form a coil track for example. Thus, a winding process does not have to be used.

In particular, the coil core is positioned between the first printed circuit board and the at least one further printed circuit board. A coil which surrounds the coil core can thereby be prepared. Furthermore, a contact surface for the at least one further printed circuit board is supplied by the coil core.

The data carrier-/transmitter device in accordance with the invention can be used in an advantageous manner on metallic objects. For example, engine blocks can be identified during the manufacture thereof by the data carrier device in accordance with the invention.

The following description of preferred embodiments serves to provide a more detailed explanation of the invention taken in conjunction with the drawings.

### BRIEF DESCRIPTION OF THE DRAWINGS

FIG. 1 shows a schematic illustration of a first exemplary embodiment of a data carrier device in accordance with the invention in the form of a plan view;

FIG. 2 a sectional view of the data carrier device in accordance with FIG. 1 along the line 2-2;

FIG. 3 a schematic illustration of the field pattern for a data carrier device in accordance with the invention without a metallic object compared with a known data carrier device;

FIG. 4 a schematic view of the field pattern of an exemplary embodiment of a data carrier device in accordance with the invention which is fixed to a metallic object compared with a data carrier device known from the state of the art;

FIG. 5 a second exemplary embodiment of a data carrier device in accordance with the invention in the form of a plan view;

FIG. 6 a sectional view of the data carrier device in accordance with FIG. 5 along the line 6-6;

FIG. 7 a sectional side view of a third exemplary embodiment of a data carrier device in accordance with the invention after assembly and during a part step of the manufacturing process; and

FIG. 8 the data carrier device in accordance with FIG. 7 during a part step of the manufacturing process.

### DETAILED DESCRIPTION OF THE INVENTION

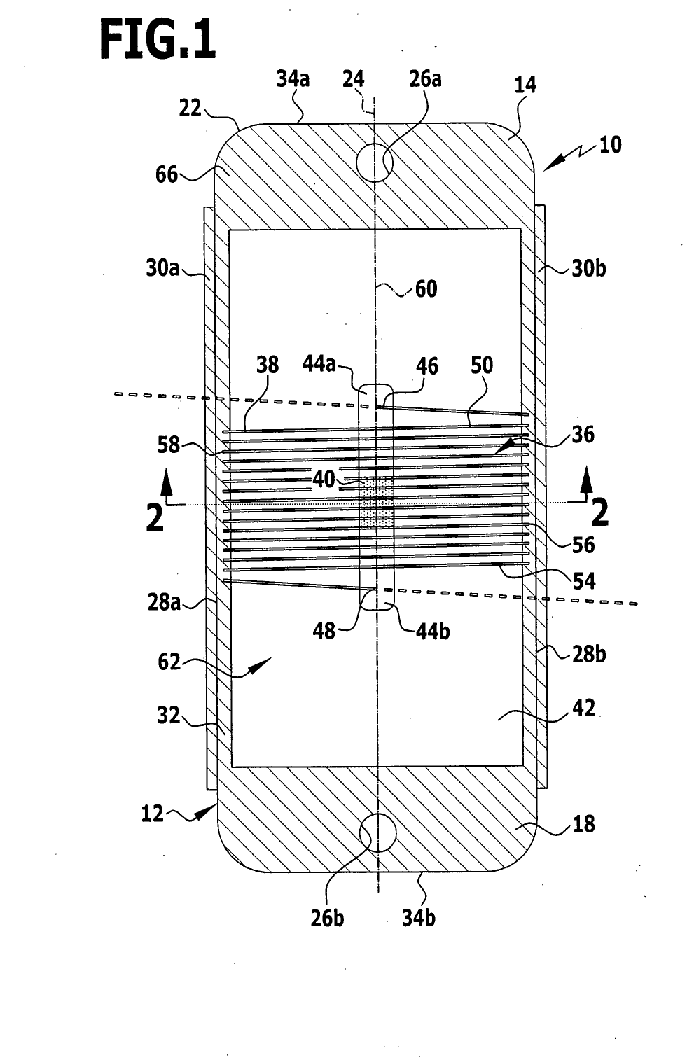

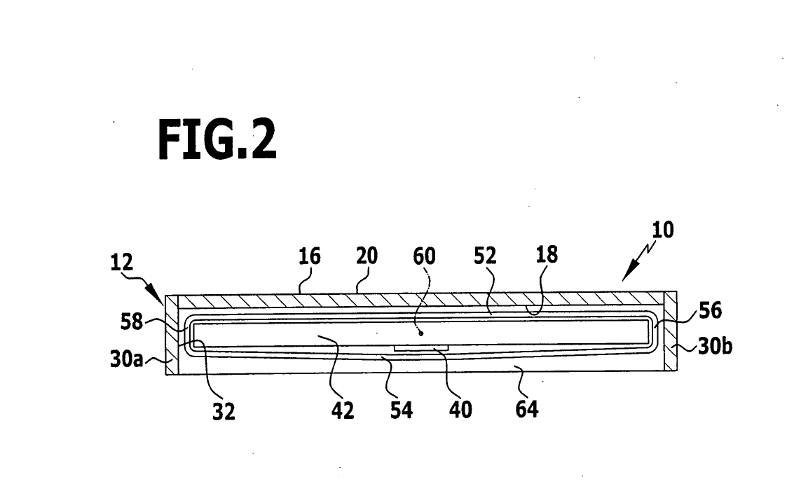

A first exemplary embodiment of a data carrier device in accordance with the invention which is shown in FIGS. 1 and 2 and is indicated by 10 therein comprises a fixing device 12 by means,of which the data carrier device 10 is fixable to an object that is intended to be identified by the data carrier device 10.

In the exemplary embodiment shown, the fixing device 12 comprises a plate 14 of a metallic material. For example, the plate 14 is made of (high grade) steel, aluminium or copper. The plate 14 has a substantially flat lower surface 16 and a substantially flat upper surface 18. The lower surface 16 and the upper surface 18 are parallel to one another. The lower surface 16 forms a contact face 20 for the data carrier device 10 on an object having a flat contact surface.

The plate 14 is of a substantially parallelepipedal shape with rounded off or chamfered corners 22.

In particular, the plate 14 is mirror-symmetrical relative to a central axis 24.

Mutually spaced through openings 26a, 26b are arranged in the plate 14. These lie on the central axis 24 for example. The fixing device 12 can be fixed to an object with the aid of said openings, by means of bolts for example. Edge strips 30a, 30b are arranged along the longer sides 28a, 28b of the plate 14. These edge strips 30a, 30b are aligned substantially in parallel with the central axis 24 and are at least approximately parallel to one another.

The edge strips 30a, 30b are substantially flush with the lower surface 16 of the plate 14 or are set back with respect to the lower surface 16; they do not project beyond the lower surface 16 so as to enable the data carrier device 10 to be fixable to the object in a simple and secure manner. They do project beyond the upper surface 18 of the plate 14. A seating space 32 is thus formed between the upper surface 18 of the plate 14 and the edge strips 30a, 30b. This seating space 32 has a substantially parallelepipedal shape. It is open towards the end faces 34a, 34b which are transverse and in particular perpendicular to the central axis 24.

In the case of the data carrier device 10, the edge strips 30a, 30b do not extend over the whole length of the plate 14 (in parallel with the central axis 24), but are set back with respect to the end faces 34a, 34b.

An oscillatory circuit 36 is arranged in the seating space 32. This oscillatory circuit 36 is formed by means of (at least) one coil 38 and a capacitance which is comprised by a circuit arrangement 40. The circuit arrangement is, in particular, an integrated circuit arrangement which is formed by an IC and which comprises the capacitance. This lies in a range of between 20 pF to 100 pF for example.

The circuit arrangement 40 comprises further components for the control of the oscillatory circuit 36.

The coil 38 is arranged on a coil core 42. The coil core 42 is made of a soft-magnetic material having a high magnetic permeability and low magnetic loss. A basically suitable material is a ferrite material.

Provision is made for the coil core 42 to be made of a flexural material. For example, the coil core 42 is made of a foil material. An example of such a soft-magnetic foil material is the material “LIQUALLOY” from the ALPS ELECTRIC CO, Ltd., 1-7, Yukigaya-otsuka-cho, Ota-ku, Tokyo, 145-8501, Japan. This material is an amorphous metal.

The coil core 42 is in the form of a parallelepiped and is adapted to the dimensions of the seating space 32.

The coil core 42 could also be called an absorber foil since lines of magnetic flux are absorbed thereby to a certain extent.

The circuit arrangement 40 is seated on an upper surface of the coil core 42. For example, it is glued to this coil core 42. In particular, the circuit arrangement 40 is seated on the central axis 24 and is central with respect to the end faces 34a and 34b.

A first conducting surface 44a is associated with the circuit arrangement 40 in the direction of the end face 34a, and it lies, in particular, on the central axis 24. Furthermore, a second conducting surface 44b is associated with the circuit arrangement 40, this said surface extending along the central axis 24 towards the end face 34b. A conductive connection between the circuit arrangement 40 and the coil 38 is produced by the conducting surfaces 44a, 44b.

The conducting surfaces 44a and 44b can also be part of the circuit arrangement 40.

The coil beginning 46 of the coil 38 is electrically and mechanically fixed to the first conducting surface 44a. The coil end 48 of the coil 38 is fixed electrically and mechanically to the second conducting surface 44b by welding or soldering for example. The coil 38 is wound around the coil core 42 between the coil beginning 46 and the coil end 48, and the coil 38 is positioned in the seating space 32.

The coil 38 comprises windings 50 which are led around the coil core 42. A winding 50 comprises a lower winding portion 52 which faces the upper surface 18 of the fixing device 12, an upper winding portion 54 which is arranged on the opposite side of the coil core 42, a transverse winding portion 56 which interconnects the lower winding portion and the upper winding portion 54, and also a transverse winding portion 58 which serves for the connection to the next winding. The transverse winding portions 56, 58 face the edge strips 30a, 30b.

The lower winding portion 52 and the upper winding portion 54 are substantially in parallel with the upper surface 18 of the fixing device 12. They lie substantially flatly on the coil core 42 (whereby the coil core has a flat lower surface and a flat upper surface).

The part of a winding 50 of greatest length is in the lower winding portion 52 and in the upper winding portion 54. In particular, at least 80% and preferably at least 90% of the overall length of a winding 50 is in the lower winding portion 52 and in the upper winding portion 54, i.e. at most 20% and preferably at most 10% of the overall length lies in the transverse winding portions 56 and 58.

That region of the conducting surfaces 44a, 44b which is covered by the windings 50 is provided with an insulating means in order to prevent electrical contact between the coil 38 and the conducting surfaces 44a, 44b apart from the coil beginning 46 and the coil end 48. To this end for example, an insulating film is arranged on the conducting surfaces 44a and 44b.

A coil axis 60 of the coil is substantially in parallel with the contact face 20 of the data carrier device 10 on an object. In particular, it is substantially coaxial with the central axis 24 of the data carrier device 10 or is in parallel therewith. Consequently, the coil axis 60 is also substantially parallel to the edge strips 30a, 30b.

A combination 62 consisting of the coil core 42, the coil 38 and the circuit arrangement 40 is positioned in the seating space 32. In particular, the height of this combination 62 is such that it does not project beyond the edge strips 30a, 30b.

This combination 62 can be cast in the seating space 32. A corresponding casting material 64 is indicated schematically in FIG. 2.

A metal element 66 is associated with the coil 38 and masks the coil 38 with respect to the object on the contact face side 20 thereof, i.e. the metal element 66 is arranged between the object and the coil 38, whereby the width of the metal element transverse to the central axis 24 (and hence transverse to the coil axis 60) is at least as broad as the coil 38. Furthermore, the length of the metal element 66 parallel to the coil axis 60 (and hence parallel to the central axis 24) is at least as great as the length of the coil 38 in this direction.

In the case of the data carrier device 10, the metal element 66 is formed by the plate 14 which is also a carrier for the combination 62. The plate 14 serving as the metal element 66 forms a backing plate for the data carrier device 10.

It is in principle also possible for the metal element 66 and the fixing device 12 to be separate from one another.

Provision may be made for the metal element 66 to be formed rigidly, for example, to be in the form of the plate 14. It is also possible for the metal element 66 to be of flexible construction.

The data carrier device 10 can be produced as follows:

The coil core 42 is prepared. The circuit arrangement 40 including the conducting surfaces 44a, 44b is arranged thereon. The coil beginning 46 is fixed mechanically and electrically to the first conducting surface 44a by welding or soldering for example. The coil 38 is then produced by winding it on the coil core 42 starting from the beginning of the coil 46. The coil end 48 is fixed mechanically and electrically to the second conducting surface 44b by welding or soldering for example.

The combination 62 of the coil core 42, the coil 38 and the circuit arrangement 40 that has been produced in such a manner is fixed on the plate 14 with the edge strips 30a, 30b and cast in place. The combination 62 is fixed to the plate 44 by oppositely located beads for example, before the casting process takes place.

The data carrier device 10 in accordance with the invention functions as follows:

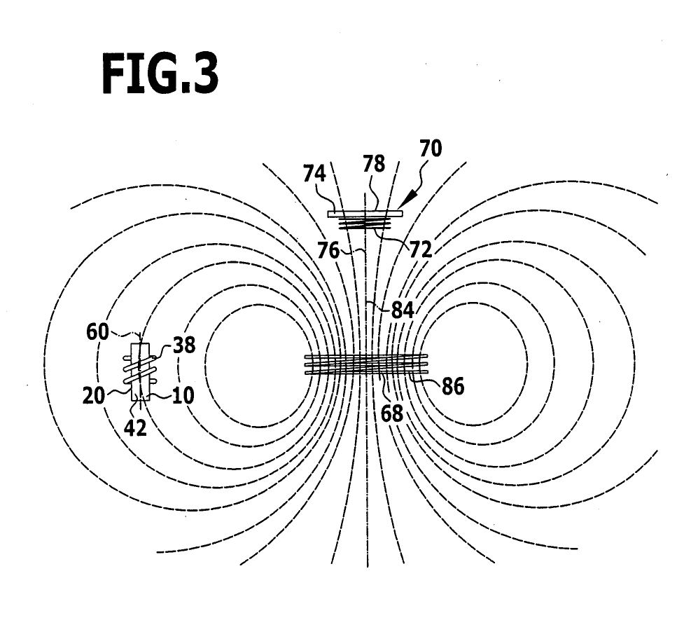

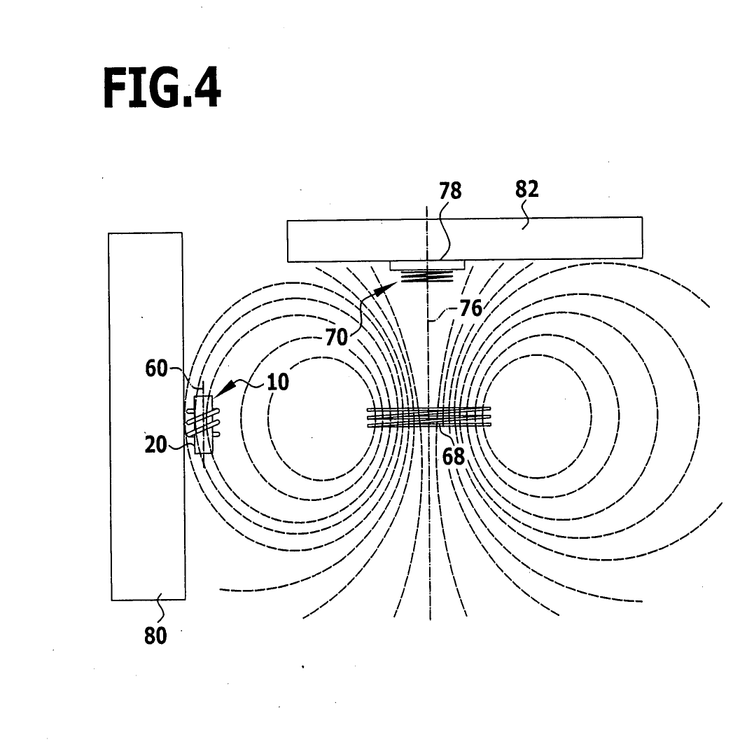

The data carrier device 10 is, in particular, an RFID data carrier device (RFID-Radio Frequency Identification). The oscillatory circuit 36 together with the circuit arrangement 40 forms a transponder. A read-receiver device 68 (FIGS. 3, 4) incorporating a read head is used for reading and, if necessary, for storing data in the data carrier device 10. Data transmission between the read-receiver device 68 and the data carrier device 10 is effected electromagnetically. The data carrier device 10 obtains the energy required for the transmission of data to the read-receiver device 68 from the latter. The oscillatory circuit 36 forms an antenna (transponder antenna). An induced current is induced in the coil 38 by the electromagnetic excitation field of the read-receiver device 68. This activates the circuit arrangement 40.

In particular, the data carrier device 10 is a passive transponder; in the case of the latter, the capacitance of the resonant circuit 36 is charged in order to provide a current supply for the circuit arrangement 40. When the circuit arrangement 40 is activated, it can receive instructions from the read-receiver device 68 or it can convey data to the read-receiver device 68. This transmission takes place by a load modulation process, i.e. by varying the electromagnetic field which is radiated by the read-receiver device 68. This variation can, in turn, be detected by the read-receiver device 68.

The data carrier device is designed as a near field data carrier device. The non-shifted oscillatory circuit frequency (see below) is approximately 13.56 MHz for example or lies in a range of between 125 kHz and 135 kHz.

The data carrier device in accordance with the invention is provided for use on a metallic object. The resonant frequency of the oscillatory circuit 36 is shifted, namely to a higher frequency usually, by the metal element 66 which is provided by the plate 14 in the case of the data carrier device 10. A defined “intrinsic” frequency shift is produced by virtue of the metal element 66 which is integrated into the data carrier device 10. The influence of a metallic object on which the data carrier device 10 is arranged is thereby greatly reduced. Thus, due to the metal element 66, a resonant frequency of the oscillatory circuit 36 is set which is modified with respect to the resonant frequency of the oscillatory circuit without a metal element 66 and in particular, it lies thereabove. However, the influence of a metallic object (such as an engine block for example) to which the data carrier device 10 is fixed is greatly reduced thereby, i.e. the external alteration of the resonant frequency by the external object is greatly reduced.

The pattern of the inductive field of the read-receiver device 68 is shown schematically in FIG. 3. A data carrier device known from the state of the art, which comprises a coil 72 that is arranged on a carrier 74 is indicated by the reference symbol 70. The coil axis 76 of the coil 72 is oriented perpendicularly to a contact face 78 of the data carrier device 70. The data carrier device 70 is placed on an object (FIG. 4) using this contact face 78.

By contrast, in the solution in accordance with the invention, the coil axis 60 is substantially in parallel with the contact face 20.

The influence of a metallic object (for the data carrier device 10) and of a metallic object 82 (for the data carrier device 70) is shown in FIG. 4. The contact face 20 of the data carrier device 10 rests on the object 80. It is oriented substantially in parallel with a surface of the object 80. The coil axis 60 is oriented substantially in parallel with the surface region to which the. data carrier device 10 is fixed.

The contact face 78 for the data carrier device 70 rests on the metallic object 82. The coil axis 76 is perpendicular to this contact face 78 and hence to the surface region of the object 82 on which the data carrier device 70 rests via its contact face 78.

One can perceive the differing field patterns of the inductive field from FIG. 4. The inductive field is altered by the objects 80, 82. It runs approximately in parallel with the surface of the metallic object 80 for the particular disposition of the data carrier device 10. This leads to a compression of the field. Such a compression of the field cannot be achieved with the data carrier device 70.

It should also be noted that the coil axis 84 of a coil 86 in the read-receiver device 68 should be aligned at least approximately parallel to the coil axes 76 or 60 in the case of the data carrier device 70 in order to enable the field to be applied effectively to the respective coils 38 and 72 in the data carrier devices 10 and 70.

Due to the alignment of the coil 38 with its coil axis 60 in parallel with the contact face 20, the lines of flux of the inductive field meet the coil core 42 at a flat angle. The lines of flux are thereby drawn to a certain extent into the coil core 42. In consequence, there is an increase in the field strength and the detection distance is increased.

It is thereby possible for example, to read out data carrier devices 10 which are fixed to metallic objects 80 using a fixed read head in the read-receiver device 68 i.e. the read head no longer has to be moved towards the object. Metallic objects 80 can be used directly for shaping the lines of flux.

Due to the metal element 66, a further increase in distance is achieved since the influence of the object 80 on the resonant frequency is greatly reduced.

The data carrier device 10 can be produced in a simple manner. For example, no rotation or turning of the coil core 42 is necessary since the coil 38 can be wound directly thereon.

Due to the use of a flexible material for the coil core 42, the danger of fracturing is prevented in comparison with a coil core in the form of a rigid ferrite rod.

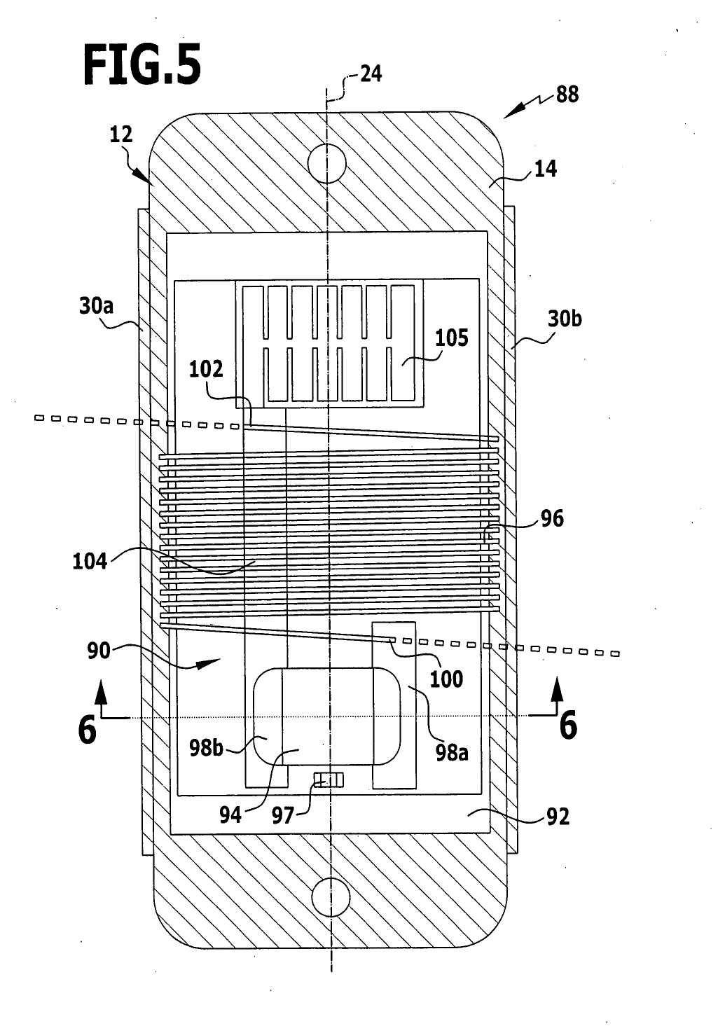

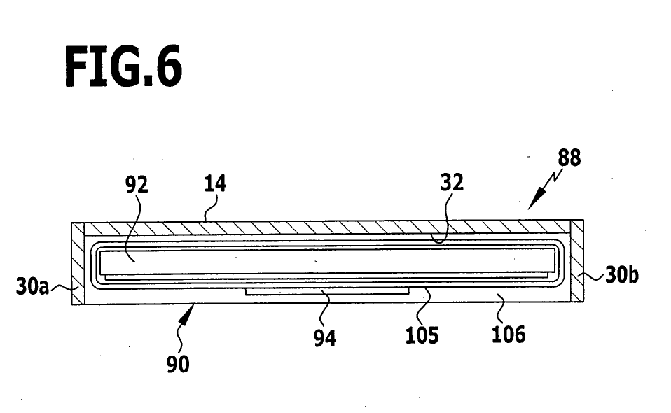

In a second exemplary embodiment of a data carrier device in accordance with the invention which is shown in FIGS. 5 and 6 and is referenced 88 therein, the fixing device is of basically the same construction as that of the data carrier device 10. The same reference symbols are therefore used. A combination 90 consisting of a coil core 92, a circuit arrangement 94 and a coil 96 is arranged in the seating space 32 of the fixing device 12 of the data carrier device 88.

The circuit arrangement 94 is seated on the coil core 92. A first conducting surface 98a and a second conducting surface 98b are associated therewith. The conducting surfaces 98a and 98b are on opposite sides taken with reference to the central axis 24. The coil beginning 100 of the coil 96 is fixed to the first conducting surface 98a. The coil end 102 of the coil 96 is fixed to the second conducting surface 98b. Hereby, the conducting surface 98a is shorter than the conducting surface 98b. The first conducting surface 98a is designed in such a way that it lies outside the coil 96 and extends up to the beginning of the coil 100. The second conducting surface 98b extends from the circuit arrangement 94 to an oppositely located end of the coil core 92. The coil 96 is wound over a region 104 of the second conducting surface 98b, whereby there is no electrical contact.

A capacitor 97 is associated with the coil 96 for the formation of an oscillatory circuit. This is soldered to the coil core 92 near an IC by means of which the circuit arrangement 94 is realized for example.

A capacitor device 105, which comprises one or more capacitors, is electrically coupled to the second conducting surface 98b. The coil 96 is positioned between the capacitor device 105 and the circuit arrangement 94.

A trimming device is formed by the capacitor device 105 which, in particular, comprises one or more laminar capacitors. For example, the overall capacitance of the oscillatory circuit of the data carrier device 88 can be deliberately modified during the production process by a laser trimming process. Thus variations in components or variations in materials that occur during production of the data carrier device 88 can be compensated.

For example, during the production of the data carrier device 88, a laser trimming process is carried out on the capacitor device 105 after a transparent casting material 106 has been applied (and after it has hardened).

In all other respects, the data carrier device 88 functions as was described above for the data carrier device 10.

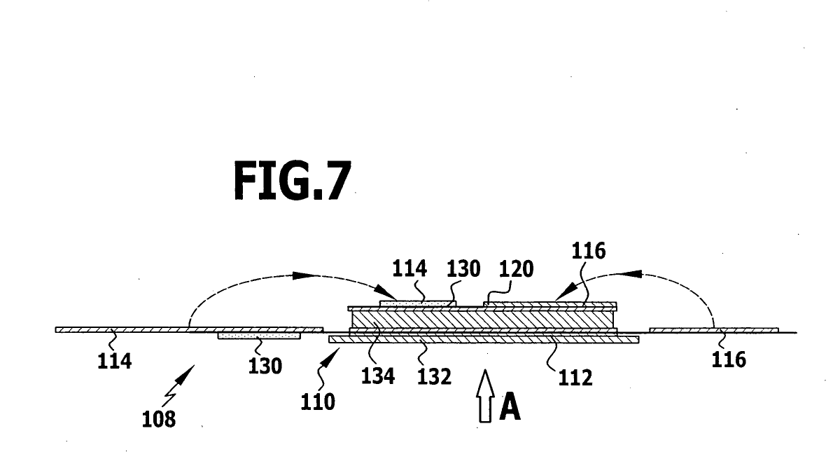

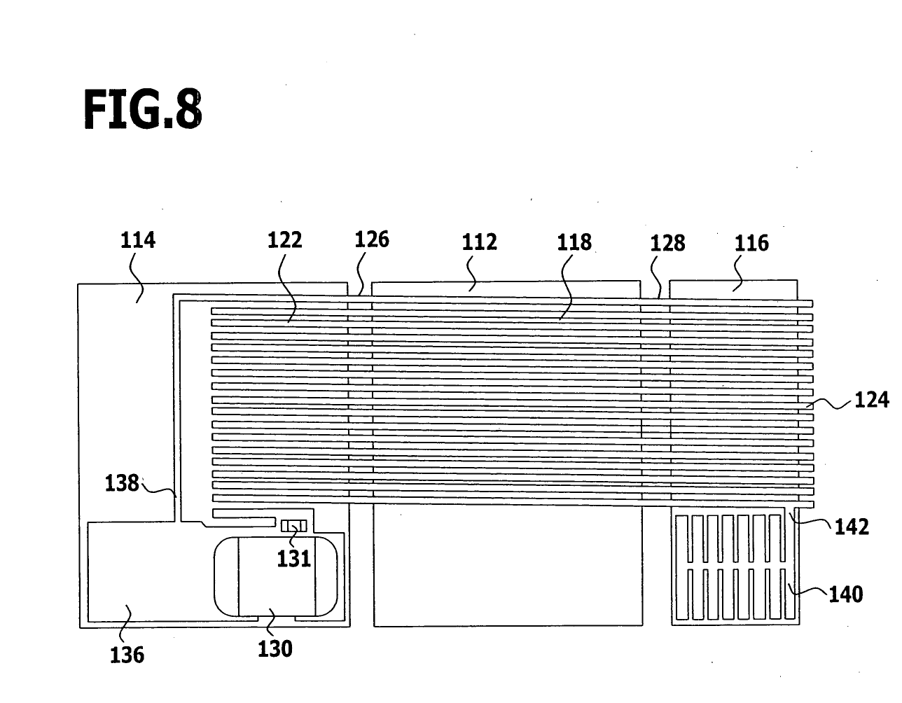

In a third exemplary embodiment of a data carrier device in accordance with the invention which is shown in FIG. 7 and is referenced 108 therein (and is shown in one state during a part step in the manufacturing process in FIG. 8), a coil is formed on a flexi-rigid composite of printed circuit boards 110. Flexi-rigid composites of printed circuit boards consist of a combination of rigid and flexible printed circuit boards which are inseparably connected to one another.

The flexi-rigid composite of printed circuit boards 110 comprises a first printed circuit board element 112, a second printed circuit board element 114 and a third printed circuit board element 116. These printed circuit board elements 112, 114 and 116 are of rigid construction. A first coil part 118 of a coil 120 of a resonant circuit of the data carrier device 108 is arranged on the first printed circuit board element 112. A second coil part 122 of the coil 120 is arranged on the second printed circuit board element 114 and a third coil part 124 of the coil 120 is arranged on the third printed circuit board element 116. The first coil part 118, the second coil part 122 and the third coil part 124 come together to form the coil 120.

The flexible connection between the first printed circuit board element 112 and the second printed circuit board element 114 is effected by the winding portions 126 of the coil 120 which connect the coil parts 118 and 122. The flexible connection between the first printed circuit board 112 and the third printed circuit board 116 is effected by the winding portions 128 of the coil 120 which interconnect the coil parts 118 and 124.

A circuit arrangement 130 and an (oscillatory circuit) capacitor 131 are arranged on the second printed circuit board element 114.

The first printed circuit board element 112 is seated, in particular, in laminar manner on a carrier 132. In particular, this carrier 132 is a metal element corresponding to the plate 14 such as was described in connection with the data carrier device 10.

A coil core 134 which, in particular, is in the form of a parallelepiped is arranged on the first printed circuit board element 112. This coil core is designed, in particular, as an absorber foil such as was described above in connection with the data carrier device 10.

In turn, the second printed circuit board element 114 and the third printed circuit board element 116 are arranged to lie on the coil core 134, whereby these contact one another electrically in order to form closed coil windings which surround the coil core 134.

To this end, the winding portions 126, 128, which produce the flexible connection between the first printed circuit board element 112 and respectively the second printed circuit board element 114 and the third printed circuit board element 116, are of such a length as substantially corresponds to the depth of the coil core 134.

The first printed circuit board element 112 is provided with a conducting surface 136 to which the coil beginning 138 of the coil 120 is coupled. The third printed circuit board element 116 is provided with a conducting surface 140 to which the coil end 142 of the coil 120 is coupled. The conducting surfaces 136 and 140 lie outside the coil windings of the coil 120. If the second printed circuit board element 114 and the third printed circuit board element 116 are positioned on the coil core 134, and in particular, if they rest thereon, then the conducting surface 140 is electrically coupled to the circuit arrangement 130 so as to provide a resonant circuit having an integrated circuit arrangement 130.

The flexi-rigid composite of printed circuit boards 110 is produced for the purposes of producing the data carrier device 108. The first printed circuit board element 112 is positioned on the carrier 132. The coil core 134 is positioned on the first printed circuit board element 112. Subsequently, the second printed circuit board element 114 and the third printed circuit board element 116 are positioned on the coil core 134 by pivoting them onto said core. When the positioning process is correct, an electrical contact between the coil end 142 and the circuit arrangement 130 is established automatically.

This arrangement can then be encapsulated.

In all other respects, the data carrier device 108 functions as was described above in connection with the data carrier device 10.

In accordance with the invention, there is also provided a transmitter device which is of basically the same construction as the data carrier devices described above. This transmitter device can be part of the read-receiver device 68. In particular, it forms an antenna device which radiates an electromagnetic field in order to subject a data carrier device thereto.

1. A data carrier-/transmitter device for fixing to an object, comprising:
an oscillatory circuit including at least one coil;
an electrical circuit arrangement to which the at least one coil is coupled; and
a fixing device having a contact face for the object;
wherein the coil axis of the at least one coil is at least approximately in parallel with the contact face of the fixing device.

2. A data carrier-/transmitter device in accordance with claim 1, wherein the contact face has a substantially flat contact surface.

3. A data carrier-/transmitter device in accordance with claim 1, wherein the fixing device comprises one or more through openings for attachment elements.

4. A data carrier-/transmitter device in accordance with claim 1, wherein the object is a metallic object.

5. A data carrier-/transmitter device in accordance with claim 1, wherein a metal element is arranged between the at least one coil and the object.

6. A data carrier-/transmitter device in accordance with claim 5, wherein the metal element is at least partially in the form of a plate or foil.

7. A data carrier-/transmitter device in accordance with claim 5, wherein the metal element masks the at least one coil from the object.

8. A data carrier-/transmitter device in accordance with claim 7, wherein the metal element is of at least the same width transverse to the coil axis and is of at least the same length parallel to the coil axis as the at least one coil.

9. A data carrier-/transmitter device in accordance with claim 5, wherein the metal element is formed as a backing plate of the data carrier device.

10. A data carrier-/transmitter device in accordance with claim 5, wherein the fixing device is formed at least partly by the metal element.

11. A data carrier-/transmitter device in accordance with claim 5, wherein the metal element is made of aluminium or steel or copper.

12. A data carrier-/transmitter device in accordance with claim 5, wherein the metal element forms a carrier for the at least one coil and/or the electrical circuit arrangement.

13. A data carrier-/transmitter device in accordance with claim 5, wherein the metal element comprises a substantially flat upper surface.

14. A data carrier-/transmitter device in accordance with claim 1, wherein the fixing device comprises one or more edge strips.

15. A data carrier-/transmitter device in accordance with claim 14, wherein the at least one edge strip is made of a metallic material.

16. A data carrier-/transmitter device in accordance with claim 14, wherein the at least one edge strip is connected to a plate-like metal element.

17. A data carrier-/transmitter device in accordance with claim 14, wherein the at least one edge strip is oriented at least approximately in parallel with the coil axis of the at least one coil.

18. A data carrier-/transmitter device in accordance with claim 14, wherein a seating space for the at least one coil and/or the circuit arrangement is formed between opposite edge strips.

19. A data carrier-/transmitter device in accordance with claim 18, wherein the end of the seating space is open with respect to the coil axis.

20. A data carrier-/transmitter device in accordance with claim 18, wherein the seating space is parallelepipedal.

21. A data carrier-/transmitter device in accordance with claim 1, wherein the electrical circuit arrangement comprises a capacitive device.

22. A data carrier-/transmitter device in accordance with claim 1, wherein the electrical circuit arrangement is formed by one or more integrated circuits.

23. A data carrier-/transmitter device in accordance with claim 1, wherein one or more trimming capacitors are associated with the electrical circuit arrangement.

24. A data carrier-/transmitter device in accordance with claim 1, wherein a coil core is associated with the at least one coil.

25. A data carrier-/transmitter device in accordance with claim 24, wherein the coil core is at least approximately parallelepipedal.

26. A data carrier-/transmitter device in accordance with claim 24, wherein the at least one coil comprises turns which are arranged around the coil core.

27. A data carrier-/transmitter device in accordance with claim 1, wherein the turns of the at least one coil comprise winding portions which are oriented at least approximately in parallel with the contact face.

28. A data carrier-/transmitter device in accordance with claim 27, wherein at least 80% of the total winding length of the coil is oriented in parallel with the contact face.

29. A data carrier-/transmitter device in accordance with claim 24, wherein the coil core is made of a flexural material.

30. A data carrier-/transmitter device in accordance with claim 24, wherein the coil core is made of a foil material.

31. A data carrier-/transmitter device in accordance with claim 1, wherein the at least one coil is wound at least partly over the circuit arrangement.

32. A data carrier-/transmitter device in accordance with claim 1, comprising a flexi-rigid composite of printed circuit boards.

33. A data carrier-/transmitter device in accordance with claim 32, wherein a first printed circuit board element is provided on which winding portions of the at least one coil are arranged.

34. A data carrier-/transmitter device in accordance with claim 33, wherein a second printed circuit board element is provided on which winding portions of the at least one coil are arranged, whereby the second printed circuit board element is connected to the first printed circuit board element in flexible manner.

35. A data carrier-/transmitter device in accordance with claim 34, wherein the connection is effected by winding portions of the at least one coil.

36. A data carrier-/transmitter device in accordance with claim 35, wherein a third printed circuit board element is provided on which winding portions of the at least one coil are arranged, whereby the third printed circuit board element is connected to the first printed circuit board element in flexible manner.

37. A data carrier-/transmitter device in accordance with claim 36, wherein the connection is effected by winding portions of the at least one coil.

38. A data carrier-/transmitter device in accordance with claim 34, wherein the circuit arrangement is arranged on the second printed circuit board element.

39. A data carrier-/transmitter device in accordance with claim 34, wherein at least one of the second printed circuit board element and the third printed circuit board element are arranged to be opposite the first printed circuit board element.

40. A data carrier-/transmitter device in accordance with claim 39, wherein a coil core is arranged between the first printed circuit board element and at least one of the second printed circuit board element and the third printed circuit board element.

41. A data carrier-/transmitter device in accordance with claim 40, wherein at least one of the second printed circuit board element and the third printed circuit board element rest on the coil core.

42. Use of the data carrier-/transmitter device in accordance with claim 1 on a metallic object.

43. A method for the production of a data carrier-/transmitter device including an oscillatory circuit, comprising:
the beginning of a coil to a circuit arrangement and
fixing the circuit arrangement to a coil core.

44. A method in accordance with claim 43, wherein the coil is produced on the coil core.

45. A method in accordance with claim 43, wherein the coil is wound around the coil core.

46. A method in accordance with claim 43, wherein the coil core is produced in the form of a foil.

47. A method in accordance with claim 43, wherein the coil core is parallelepipedal.

48. A method in accordance with claim 43, wherein the coil is wound flat.

49. A method in accordance with claim 43, wherein an end of the coil is fixed to the circuit arrangement.

50. A method in accordance with claim 43, wherein the combination of a coil core and a coil and a circuit arrangement is fixed to a fixing device for the purposes of fixing the data carrier-/transmitter device to an object.

51. A method in accordance with claim 43, wherein a metal element is positioned on the combination of a coil arrangement and a coil and a circuit arrangement.

52. A method in accordance with claim 50, wherein the fixing device is formed by a metal plate or comprises a metal plate.

53. A method in accordance with claim 1, wherein a trimming device is produced.

54. A method in accordance with claim 53, wherein a trimming process is carried out .on the produced data carrier-/transmitter device.

55. A method in accordance with claim 43, wherein a first printed circuit board element and a partial coil are produced and at least one further printed circuit board element including a further partial coil is produced, and wherein the first printed circuit board element and the at least one further printed circuit board element are connected together in flexible manner by coil portions.

56. A method in accordance with claim 55, wherein the coil core is positioned between the first printed circuit board element and the at least one further printed circuit board element.

57. A data carrier-/transmitter device for fixing to an object, comprising:
an oscillatory circuit including at least one coil;
an electrical circuit arrangement to which the at least one coil is coupled; and
a fixing device having a contact face for the object;
wherein a metal element is arranged between the at least one coil and the object.
